(19) United States
(12) Patent Application Publication
(10) Pub. No.: US 2026/0365791 A1
(43) Pub. Date: Nov. 19, 2026

(54) PROCESS FOR PREPARATION OF POLYACETALPOLYOLS AND THEIR APPLICATION IN PU SYSTEMS

(71) Applicant: BASF SE, Ludwigshafen am Rhein (DE)

(72) Inventors: Anna Maria CRISTADORO, Lemfoerde (DE); Zeljko TOMOVIC, Eindhoven (NL); Patrick Joël SCHARA, Eindhoven (NL); Veronika WLOKA, Ludwigshafen am Rhein (DE); Rintje Pieter SIJBESMA, Eindhoven (NL)

(73) Assignee: BASF SE, Ludwigshafen am Rhein (DE)

(21) Appl. No.: 19/141,617

(22) PCT Filed: Dec. 22, 2023
(86) PCT No.: PCT/EP2023/087639

§ 371 Date: Jun. 20, 2025

(30) Foreign Application Priority Data
Dec. 23, 2022 (EP) 22216457.6

(51) Int. Cl. C08G 71/04; C08J 11/08

(52) U.S. Cl. CPC C08G 71/04; C08J 11/08

(57) ABSTRACT

The present invention is directed to a process for the preparation of polyacetal polyol comprising the step (i) of reacting a compound (D1) having at least one OH group with a compound (C1) in the presence of a solid acid catalyst, wherein the compound (C1) is selected from the group consisting of vinylethers, aldehydes and acetals, the polyacetal polyol obtained in the process as well as the use of a polyacetal polyol obtained or obtainable according to said process and a process for preparing a polyurethane.

The present invention is directed to a process for the preparation of polyacetal polyol comprising the step (i) of reacting a compound (D1) having at least one OH group with a compound (C1) in the presence of a solid acid catalyst, wherein the compound (C1) is selected from the group consisting of vinylethers, aldehydes and acetals, the polyacetal polyol obtained in the process as well as the use of a polyacetal polyol obtained or obtainable according to said process and a process for preparing a polyurethane.

Polyurethane materials are an important class of plastic materials used in numerous applications spanning a variety of industries due to their robustness, longevity, and ability to be tailored for specific end-use applications. Moreover, polyurethane materials are more environmentally friendly and sustainable materials when compared to some plastic materials used in industry, for example due to their use in energy conserving end-use applications such as thermal insulation (e.g., building and pipe insulation) and light weighting of components. As a result of increasing demand and quantity of produced PU materials a large amount of PU waste is generated every year which is either used for incineration or ending up in landfills, posing severe environmental problems. However, polyurethane materials are difficult to recycle via either mechanical or chemical recycling methods.

Chemical recycling of polyurethanes is for example possible using glycolysis process (chemical decomposition of urethane by active hydrogen atom present in the glycol structure), however it requires a lot of energy, severe reaction conditions like high temperature >220 °C, huge excess of glycol, shows limited selectivity and create a very complex mixture of polyols and oligomers, difficult or impossible to separate (Polym. Degard. Stab. 2002, 75, 413-421; Polym. Degard. Stab. 2004, 147-151; ChemSusChem 2020, 13, 3835, 3843). There is still a need in the polyurethane industry to develop other processes that ease the recyclability of polyurethane materials thereby reducing the total amount of energy, time, machinery, and reagents needed to recycle such materials.

For example, the incorporation of special functional groups or smart monomers into the polymers allows to depolymerize the resulting polymer in a simple process which reduces the effort for a recycling process of the material. Several suitable monomers for the synthesis of polyurethanes which can be easily depolymerized are described in the literature.

T. Hashimoto et al. (J. Appl. Polym. Sci., 2016, 133, 44088) describe the synthesis of polyols via polyaddition of various mono vinyl ethers and diols using p-toluenesulfonic acid (PTSA) as a homogeneous catalyst. The obtained polyols were used for the synthesis of PU elastomers which can be decomposed. This process requires large amount of organic solvents (THF, dichloromethane), leads to the formation of huge amount of cyclic acetals as by-products and extraction has to be used to remove the catalyst in the form of salt.

Z. Petrovic et al. (J Polym Environ., 2009, 17, 123-130) describe the synthesis of polyols via polyaddition of triethylene glycol divinylether and diols in bulk at 80 °C using oxalic acid as a catalysts, i.e. a homogeneous catalyst. The polyols can also be used for the synthesis of polyurethanes. This process leads to the formation of small amount of cyclic acetals as by-products. The polyols are cloudy due to the presence of the salt formed from the acid and DABCO. The main disadvantage in this case is the fact that the salt will remain in the polyol which could have potentially negative effect on PU reactivity and properties, depending on the type of PU system.

WO 2021/236385 A1 discloses the synthesis of polyols suitable for the preparation of polyurethanes via polyaddition of triethylene glycol divinylether (TEGDVE) and diols in bulk at 40 °C using p-toluenesulfonic acid as a homogeneous catalyst Also this process leads to the formation of huge amounts of by-products when 1,4-butanediol or smaller diols are used as monomers. Furthermore, colored polyols are obtained. The main disadvantage also in this case is the fact that the salt and excess of the amine used for the neutralization of catalyst will remain in the polyol which could have negative effect on PU reactivity, stability and properties.

The main problem related to the use of acids such as oxalic acid and p-toluenesulfonic acid as homogeneous catalysts is the fact that the acid has to be neutralized at the end of the reaction. This is typically done using DABCO, DMCHA or KOH and the salt is formed which should be removed from the polyol. This is an extra step and the formation of salt that can be filtrated is also a big challenge. Alternative is purification of polyols using extraction methods, however, this is hardly applicable on industrial scale.

It was an object of the present invention to provide polyols for the preparation of polyurethanes which result in polyurethanes which can be easily decomposed under mild conditions and which can be prepared in high purity in a simple process.

The problem is solved in accordance with the invention by a process for the preparation of polyacetal polyol comprising the step (i) of reacting a compound (D1) having at least one OH group with a compound (C1) in the presence of a solid acid catalyst, wherein the compound (C1) is selected from the group consisting of vinylethers, aldehydes and acetals.

It has been surprisingly found that polyols containing acetal groups can be prepared using solid acid catalysts in a simple process and preferably also minimizing side reactions. Surprisingly, the formation of cyclic acetals when 1,4-butanediol or smaller diols are used as monomers can be significantly reduced. Furthermore, when using monomers with five or more carbon atoms the amount of cyclic products is neglectable.

Furthermore, it has been found that the polyacetal polyols can be easily separated from the catalyst.

The obtained polyacetal polyols can be used in various polyurethane elastomers and thermosets. Polyurethanes based on acetal-containing polyols exhibit good properties and stability under standard conditions. On the other hand, the instability of acetal groups in media of very low pH can be used for the smooth depolymerization of polyurethanes under mild conditions (e.g. treatment with aqueous acid at low temperature for example up to 90 °C), to give the corresponding small monomers (e.g. ethylene glycol, butanediol, etc.) which can be isolated, using standard separation techniques. This approach allows also easier separation of small monomers and other additives such as flame retardants, surfactants, etc. The recycled monomers can be reused for the synthesis of virgin polymers (“back to monomer recycling”) and the “closed loop” recycling of polyurethanes could be achieved.

Furthermore, the process according to the present invention also allows the synthesis of fully bio-based polyacetal polyols, if commercially available bio-based compounds such as for example ethylene glycol, propanediol, butanediol and glycerol are used as raw materials.

It has been found that solid acidic catalysts can be used for the synthesis of polyacetal containing polyols and catalysis. In the context of the present invention, a solid catalyst is a catalyst which is essentially solid under the conditions of the process, in particular solid under the reaction conditions of step (i) of the process according to the invention. Typically, the catalyst is not dissolved in the reaction mixture. The catalysts can be used in continuous or discontinuous process. The big advantage is that such solid heterogeneous catalyst can be easily removed after the reaction by simple filtration. Thus, the polyol with very low acid values such as an acid value below 0.2 mgKOH/g, more preferable below 0.1 mgKOH/g, even more preferable below 0.05 mgKOH/g and the most preferable below 0.03 mgKOH/g can be obtained. Furthermore, after filtration, the catalyst can be washed, dried and reused several times. Also a continuous production of the polyol using the solid acidic catalysts according to the present invention is possible.

According to the present invention, the process comprises step (i) of reacting a compound (D1) having at least one OH group with a compound (C1) in the presence of a solid acid catalyst. Compound (C1) is selected from the group consisting of vinylethers, aldehydes and acetals.

Compound (D1) has at least one OH group and may also have further functional groups, in particular further OH groups. Preferably, compound (D1) has 1 to 8, preferably 2 to 6, more preferable 2 to 4, particularly preferable 2 to 3 OH groups and the most preferable 2 OH groups. Also water or acids and/or esters such as dicarboxylic or tricarboxylic acids and esters may be used as compound (D1).

Suitable compounds (D1) may for example have a functionality of from 1 to 8, preferably from 2 to 3. According to a further embodiment, the present invention is also directed to the process for the preparation of polyacetal polyol as disclosed above, wherein compound (D1) has a functionality of from 1 to 8, preferably from 2 to 3.

Suitable compounds (D1) may for example have a molecular weight of less than 5000 g/mol, preferable less than 2000 g/mol, more preferable less than 1000 g/mol, even more referable less than 500 g/mol and the most preferable less than 200 g/mol.

According to a further embodiment, the present invention is also directed to the process for the preparation of polyacetal polyol as disclosed above, wherein compound (D1) has a molecular weight of less than 5000 g/mol.

Unless otherwise noted, the molecular weight can be determined via ¹H-NMR end group quantification or can be calculated from the OH number according to EN ISO 4629-1:2016 in the context of the present invention.

Suitable compounds (D1) may in particular be selected from the group consisting of monools, diols, and triols with 1 to 20 C-atoms, preferably from the group consisting of monools, diols and triols with 1 to 18 C-atoms, preferably 2 to 12 C-atoms and even more preferable with 2-6 C-atoms. According to a further embodiment, the present invention therefore is also directed to the process for the preparation of polyacetal polyol as disclosed above, wherein the compound (D1) is selected from the group consisting of monools, diols, and triols with 1 to 18 C-atoms, preferably from the group consisting of monools, diols and triols with 2 to 6 C-atoms.

Suitable are for example aliphatic dialcohols such as butanediol, pentanediol, hexanediol or decanediol and the respective isomers, preferably pentanediol and/or hexanediol, in particular hexanediol. In addition to these alcohols, further mono-, di- or polyalcohols may also be used for example those having a molecular weight of 62 to 400 g/mol. Examples are monoethylene glycol, 1,2- or 1,3-propanediol, 2-methyl-1,3-propandiol, 3-methyl-1,5-pentanediol, diethylene glycol, dipropylene glycol, triethylene glycol, tripropylene glycol, PTHF 250, bisphenols, and mixtures of polyhydric alcohols. Suitable active hydrogen compounds may for example be 1,2-, 1,3- and 1,4-butanediol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-2,5-diol, 1,6-hexanediol, heptane-1,2-diol 1,7-heptanediol, 1,8-octanediol, 1,2-octanediol, 1,9-nonanediol, 1,2-decanediol, 1,10-decanediol, 1,2-dodecanediol, 1,12-dodecanediol, 1,5-hexadiene-3,4-diol, 2,2-Bis(4-hydroxycyclohexyl)propane, neo-pentyl glycol (2,2-dimethylpropane-1,3-diol), 2,2-diethylpropane-1,3-diol, 2-methyl-2-ethylpropane-1,3-diol, 2-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, and tripropylene glycol, 1,1-dimethylethane-1,2-diol, 2-butyl-2-ethyl-1,3-propanediol, 2-ethyl-1,3-propanediol, neopentyl glycol, hydroxypivalic acid neopentyl glycol ester, 2-ethyl-1,3-hexanediol, 2,4-diethyloctane-1,3-diol, cyclic aliphatic diol compounds having 3 to 14 carbon atoms, for example tetramethylcyclobutanediol, 1,2-, 1,3- and 1,4-cyclohexanediol, 1,1-, 1,2-, 1,3- and 1,4-cyclohexanedimethanol, 1,2-, 1,3- or 1,4-cyclooctanediol, 4,8-bis(hydroxymethyl)tricyclo[5.2.1.02,6]decane, norbornanediol, pinanediol, decalindiol, 2,2-bis(4-hydroxycyclohexyl)propane, bis(4-hydroxycyclohexane)isopropylidene; aromatic diols such as for example 2,5-bis(hydroxymethyl)furan, 3,4-bis(hydroxymethyl)furan, bis(2-hydroxyethyl) terephthalate, 1,4 benzenediol, hydroquinone bis(2-hydroxyethyl) ether, bisphenol A, bisphenol AP, bisphenol AF, bisphenol B, bisphenol BP, bisphenol C, bisphenol C2, bisphenol E, bisphenol F, bisphenol G, bisphenol M, bisphenol S, bisphenol P, bisphenol PH, bisphenol TMC, bisphenol Z, tetrabromobisphenol A and aliphatic alcohols having 2 to 20 carbon atoms and further functional groups, or mixtures of two or more thereof.

It is particularly preferable when the alcohol component comprises monoethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol or 1,10-decanediol, in particular 1,4-butanediol, 1,5-pentanediol and 1,6-hexanediol. Furthermore, preferable diols are diethylene glycol and dipropylene glycol.

According to the present invention, also compounds having one free OH group and one or more protected OH groups may be used as compound (D1).

According to the present invention, also compounds having three or more OH groups may be used as compound (D1). Suitable are for example 1,2,4 butanetriol, trimethylolethane, 1,2,6 hexanetriol, trimethylolethane, butane-1,2,3,4-tetrol, benzene-1,2,3-triol, xylose, deoxyribose, mannose, sorbose, tagatose, galactose, ribose, fructose, mannitol, sorbitol, fucitol, galactitol, iditol, xylitol, volemitol, glycerol, glucose, sucrose pentaerythritol, dipentaerythritol, diglycerol or trimethylolpropane and also alkoxylated derivatives of the compounds having three or more OH groups.

Also suitable are polyether diols and higher functional polyetherols, in particular polyethylene glycols HO(CH2CH2O)n-H, higher polypropylene glycols HO(CH[CH3]CH2O)n-H, where n is an integer and n≥4, e.g., 4 to 20, and polyethylene-polypropylene glycols, more particularly those having 4 to 20 repeating units, it being possible for the sequence of the ethylene oxide and propylene oxide units to be blockwise or random, and polytetramethylene glycols, more particularly those having 4 to 20 repeating units, and poly-1,3-propanediols, more particularly those having 4 to 20 repeating units. Suitable compounds may have a functionality of 1 to 6, more preferable 2 to 6.

Amongst polyester polyols used as component D1 preference is given to polyester polyols based on a diol component selected from the group consisting of butanediol, neopentyl glycol, hexanediol, ethylene glycol, diethylene glycol and mixtures thereof, and a dicarboxylic acid component selected from the group consisting of adipic acid, glutaric acid, succinic acid, phthalic acid, isophthalic acid and combinations thereof. Particular preference is given to polyester polyols based on ethylene glycol and/or butanediol and/or neopentyl glycol and/or hexanediol with adipic acid and/or phthalic acid and/or isophthalic acid.

Polyester polyols suitable also include polylactones, in particular poly-C4-C12-lactones, especially polycaprolactones (PCL). Polylactones refer to aliphatic polyesters obtainable by ring-opening polymerization of lactones, in particular C4-C12-lactones, especially epsilon-caprolactones (ε-caprolactone). Polycaprolactones have repeating monomer units of the general formula (1) [—O—CHR—(CH2)m-CO—], in which m is 4 to 10, in case of caprolactone m=4, and R is hydrogen. In the context of the invention, the term polycaprolactone is understood to mean both homopolymers of epsilon-caprolactone and copolymers of epsilon-caprolactone. Suitable copolymers are, for example, copolymers of epsilon-caprolactone with monomers selected from the group consisting of lactic acid, lactide, hydroxyacetic acid and glycolide. The polyester polyols are customary components which are known e.g. from Ullmanns Encyklopädie der technischen Chemie [Ullmann's Encyclopedia of Industrial Chemistry], 4th edition, volume 19, pp. 62 to 65.

In the context of the present invention, also mixtures of two or more aliphatic dialcohols can be used.

According to step (i), compounds (D1) and (C1) are reacted under suitable conditions. (C1) is selected from the group consisting of vinylethers, aldehydes and acetals. According to the present invention, the reaction might be selected from the group consisting of polyaddition, polycondensation or transacetalization. Suitable reaction conditions for the reaction are in principle known to the person skilled in the art. Polyaddition is typically done at 0′C to 150 °C, more preferable at 10 °C to 120 °C, more preferable on 10 °C to 90 °C, even more preferable 15 °C to 70 °C and most preferable at 20 °C to 50 °C. Polycondensation and transacetalization are done at temperature higher than 0′C, typically at 0′C to 250 °C, more preferable at 10 °C to 150 °C, more preferable on 20 °C to 110 °C, even more preferable 25 °C to 90 °C and the most preferable 40 °C to 90 °C.

Typically, the solid acid catalyst is solid under the reaction conditions of step (i). According to a further embodiment, the present invention relates to a process for the preparation of polyacetal polyol comprising the step (i) of reacting a compound (D1) having at least one OH group with a compound (C1) in the presence of a solid acid catalyst, wherein the compound (C1) is selected from the group consisting of vinylethers, aldehydes and acetals, wherein the catalysts solid under the reaction conditions of step (i).

According to a further embodiment, the present invention therefore is also directed to the process for the preparation of polyacetal polyol as disclosed above, wherein the reaction according to step (i) is a polyaddition, polycondensation or transacetalization.

In case compound (C1) is selected from vinylethers, suitable compounds are for example divinyl ethers such as 1,4-butanediol divinyl ether, diethylene glycol divinyl ether, triethylene glycol divinyl ether or 1,4-cyclohexanedimethanol divinyl ether, hydroxy functional mono vinyl ethers such as for example ethylene glycol vinyl ether, 1,4-butanediol vinyl ether, diethylene glycol vinyl ether, 1,6-hexanediol vinyl ether or 1,4-cyclohexanedimethanol vinyl ether. Also mono- or divinylethers of polytetrahydrofuranes having a molecular weight in the range of from 200 to 1400 g/mol may be used such as for example PTHF 250 or PTHF 1000, mono vinyl ethers such as for example ethyl vinyl ether, 2-ethylhexyl vinyl ether, tetra ethylene glycol methyl vinyl ether, dodecyl vinyl ether and in general vinyl ethers containing between 3 and 20 carbon atoms. Suitable vinyl ethers may for example be prepared by known techniques from the compounds (D1) as disclosed above.

In the context of the present invention, also mixtures of two or more vinylethers can be used.

In case compound (C1) is selected from aldehydes, such aldehydes are aliphatic aldehydes such as mono-aliphatic aldehydes with 4 to 12 carbon atoms or aromatic aldehydes such as for example benzaldehyde. Suitable compounds are also for example dialdehydes such as glutaraldehyde, glyoxal, terephthalaldehyde and trialdehydes or aldehydes with further functional groups, for example hydroxy-functionalized aldehydes such as for example vanillin, 7-hydroxy-3,7-dimethyl-octanal, 2-hydroxybenzaldehyde, 4-hydroxybenzaldehyde, 2,3-dihydroxybenzaldehyde, hydroxymethylfurfural, lactaldehyde, 3-hydroxybutanal, hydroxypivaldehyde, 5-Hydroxymethyl-2-furaldehyde. Particularly suitable are monoaldehydes such as linear aliphatic monoaldehydes, for example formaldehyde, paraformaldehyde, trioxane, acetaldehyde, paraldehyde, propionaldehyde, valeraldehyde, hexanaldehyde, heptaldehyde and aldehydes with up to 12 C-atoms, 2-trans-hexen-1-al, 4-heptenal, 3-ethoxy-2-methylpropenal branched aliphatic monoaldehydes such as for example 2-ethylhexanal, 2-methylpentanal, isobutyraldehyde, 2-methylbutyraldehyde, 2,2-dimethylpropionaldehyde, 3-methylvaleraldehyde, 4-methylvaleraldehyde, 2-ethylbutyraldehyde, benzenepropanal, cyclohexanecarboxaldehyde, 2,2-dimethylbutyraldehyde, 3,3-dimethylbutyraldehyde 3-methylbutanal, aromatic monoaldehydes such as for example benzaldehyde, 4-methoxybenzaldehyde, or phenyl acetic aldehyde, 4-isopropylbenzaldehyde, furfural, methoxybenzaldehyde, 1-naphthaldehyde, and also aliphatic ketones such as for example cyclopentanone, 2,3-butanedione 2,6-dimethyl-4-heptanone, 5-methyl-2-hexanone, acetone, methylhept-5-en2-one, diethylketone, cyclododecanone, methyl ethyl ketone aromatic ketones such as acetophenone, 1-phenylpentan-1-one, diphenylmethanone and ketones containing other functional groups such as 3-hydroxyacetophenone and 3-hydroxybutanone. More preferable aldehydes (C1) are monoaldehydes such as benzaldehyde, heptaldehyde, valeraldehyde and aldehyde precursors such as paraldehyde and paraformaldehyde.

In the context of the present invention, also mixtures of two or more aldehydes can be used.

In case compound (C1) is selected from acetals, suitable compounds are for example acetals such as aliphatic acetals with one or more acetal groups, for example dimethoxymethane, 1,1-dimethoxyethane, 1,1-diethoxyethane, 1,1-diethoxypropane, 1,1,3,3-tetramethoxypropane, succinaldehyde bis(dimethyl acetal), 2-chloro-1,1-diethoxyethane, isobutyraldehyde diethyl acetal, methylglyoxal 1,1-dimethyl acetal, nonanal diethyl acetal, 1,1,2-trimethoxyethane aromatic acetals, for example benzaldehyde dimethyl acetal, 4-methoxybenzaldehyde dimethyl acetal, phenylacetaldehyde dimethyl acetal, 2-furaldehyde diethyl acetal, or diacetales such as for example 1,1,3,3-tetramethoxypropane and tetrahydro-2,5-dimethoxyfuran and also ketals such as 1,1-dimethoxycyclohexane, 2,2-diethoxypropane, 1,1-dimethoxycyclopentane and acetone dibutyl acetal. More preferable acetals (C1) are monoacetals such as dimethoxymethane, 1,1-diethoxyethane, 1,1-diethoxypropane and benzaldehyde dimethyl acetal.

According to a further embodiment, the present invention is also directed to the process for the preparation of polyacetal polyol as disclosed above, wherein compound (C1) is selected from the group consisting of divinyl ethers and mono vinyl ethers.

In the context of the present invention, also mixtures of two or more acetals or ketals can be used.

According to a further embodiment, the present invention is also directed to the process for the preparation of polyacetal polyol as disclosed above, wherein compound (C1) is selected from the group consisting of linear aliphatic aldehydes, branched aliphatic aldehydes, aromatic aldehydes, and ketones.

According to a further embodiment, the present invention therefore is also directed to the process for the preparation of polyacetal polyol as disclosed above, wherein compound (C1) is selected from the group consisting of aliphatic acetals, aromatic acetals, and ketals.

According to the present invention, the reaction takes place in the presence of a solid acid catalyst.

Solid acids in the context of the present invention are solids which possess acidic sites at their (inner and outer) surface on which a base may be chemically adsorbed. Preferably, according to the definition of Bronsted and Lewis, a solid acid in the context of the present invention has the tendency to donate a proton or to accept an electron pair. The solid acid catalysts suitable in the context of the present invention may differ in their chemical composition, in the amount, type and strength of acidic sites and also in physical properties like for examples specific surface area and porosity and therefore accessibility of the catalytic active sites.

Suitable solid acid catalysts in the context of the present invention preferably have a specific surface area of at least 10 m²/g, especially of at least 100 m²/g, more preferable of at least 200 m²/g.

Suitable solid acid catalysts furthermore preferably have an acidity, determined as the amount of acid measured by ammonia TPD as described in the examples of at least 0.10 mmol/g, especially of at least 0.15 mmol/g, more preferable of at least 0.20 mmol/g.

Suitable solid acid catalysts furthermore preferably have acid sites of medium strength which correspond to Tₘₐₓ measured by ammonia TPD in the range of 340-380 °C.

Solid acid catalysts suitable in the context of the present invention include silico-aluminates or alumo-silicates, such as for example zeolites, silicoaluminophosphates, amorphous alumosilicates, clays. Suitable zeolites are for example ordered microporous alumosilicates (BEA, MOR . . . ). Alumosilicates which are available in an amorphous, less ordered and less acidic form as ASA (=amorphous silica alumina) catalyst may also be used in the context of the present invention. Also clay catalysts belonging to the class of silicates with a certain acidity, or mesoporous alumo-silicates materials like MCM-22 may be used. Furthermore, silica-alumina hydrates and the corresponding oxides may be used in the context of the present invention, for example “Siral” and “Siralox” materials from Sasol.

Suitable are also metal oxides and metal oxide mixtures which are acidic, such as for example titania, zirconia, niobia, solid phosphoric acid, sulfated zirconia or heteropolyoxometallates.

Another group of suitable solid acid catalysts which may be used are polymers and resins containing acidic structural units such as polystyrene with sulfonic acid groups. One example of such cationic ion exchange resins is Amberlyst 15.

Suitable further catalysts can be Metalorganic Frameworks (MOFs) as they are described, for example, in. U.S. Pat. No. 5,648,508, EP-A-0 709 253, M. O'Keeffe et al., J. Sol. State Chem., 152 (2000) p. 3-20, H. Li et al., Nature 402 (1999) p. 276 seq., M. Eddaoudi et al., Topics in Catalysis 9 (1999) p. 105-111, B. Chen et al., Science 291 (2001) p. 1021-23.

The metal ions forming the metal-organic framework material employed according to the present invention are preferably selected from the groups Ia, IIa, IIIa, IVa to VIIIa and Ib to VIb of the periodic system of the elements. Among these metals, particular reference is made to Mg, Ca, Sr, Ba, Sc, Y, Ti, Zr, Hf, V, Nb, Ta, Cr, Mo, W, Mn, Re, Fe, Ru, Os, Co, Rh, Ir, Ni, Pd, Pt, Cu, Ag, Au, Zn, Cd, Hg, Al, Ga, In, Tl, Si, Ge, Sn, Pb, As, Sb, and Bi, Zn, Cu, Ni, Pd, Pt, Ru, Rh and Co. With respect to the metal ions of the aforementioned elements, particular reference is made to: Mg⁺, Ca²⁺, Sr²⁺, Ba²⁺, Sc³⁺, Y³⁺, Ti⁴⁺, Zr⁴⁺, Hf⁴⁺, V⁴⁺ V³⁺ V²⁺ Nb³⁺, Ta³⁺, Cr³⁺, Mo³⁺, W³⁺, Mn³⁺, Mn³⁺ Mn²⁺, Re³⁺, Re²⁺, Fe³⁺, Fe²⁺, Ru³⁺, Ru²⁺, Os³⁺, Os²⁺, Co³⁺ Co²⁺, Rh²⁺, Rh⁺, Ir²⁺, Ir⁺, Ni²⁺, Ni⁺, Pd²⁺, Pd⁺, Pt²⁺, Pt, Cu⁺, Cu⁺, Ag⁺, Au, Zn²⁺, Cd²⁺, Hg²⁺, Al³⁺, Ga³⁺, In³⁺, Tl³⁺, Si⁴⁺, Ge⁴⁺, Ge²⁺, Sn⁴⁺, Sn²⁺, Pb⁴⁺, Pb²⁺, As⁵⁺, As³⁺, As⁺, Sb⁵⁺, Sb³⁺, Sb⁺, Bi⁺, Bi³⁺ and Bi⁺. In another embodiment, the metal organic framework has a metal or metal ion with a molecular geometry selected from the group consisting of trigonal planar, tetrahedral, square planar, trigonal bipyramidal, square pyramidal, octahedral, trigonal prismatic, pentagonal bipyramidal, paddle-wheel, and square antiprismatic.

The at least bidentate organic ligands present in the metal-organic framework material are capable of coordinating to the metal ion. Such ligands are known to the person skilled in the art.

The at least bidentate organic ligand, is preferably selected from: i) alkyl groups having from 1 to 10 carbon atoms, ii) aryl groups having from 1 to 5 phenyl rings, iii) alkyl and aryl amines carrying one or more alkyl groups having from 1 to 10 carbon atoms and/or one or more aryl groups having from 1 to 5 phenyl rings, which are covalently substituted by at least one functional group X which can coordinately bind to the metal ion and which is selected from the group consisting of CO₂H, CS₂H, NO₂, SO₃H, Si(OH)₃, Ge(OH)₃, Sn(OH)₃, Si(SH)₄, Ge(SH)₄, Sn(SH)₃, PO₃H, AsO₃H, AsO₄H, P(SH)₃, As(SH)₃, CH(RSH)₂, C(RSH)₃, CH(RNH₂)₂, C(RNH₂)₃, CH(ROH)₂, C(ROH)₃, CH(RCN)₂, C(RCN)₃, wherein R is an alkyl group having from 1 to 5 carbon atoms, or an aryl group consisting of 1 to 2 phenyl rings, and CH(SH)₂, C(SH)₃, CH(NH₂)₂, C(NH₂)₂, CH(OH)₂, C(OH)₃, CH(CN)₂ and C(CN)₃. WO 02/088148 discloses bidentate organic ligand from the group of aromatic compounds which can carry one or more substituents. The content of WO 02/088148, pages 8-14 is herein fully incorporated by reference.

Preferred catalysts are selected from the group of mixed oxides containing alumina and silica (alumosilicates). They can be obtained by co-precipitation or controlled hydrolysis of salts (e.g. using Al(NO₃)3·9H₂O and/or NaAlO₂ and/or AlCl₃ as Al precursor and tetraethoxysilane=TEOS as Si precursor), also both the Al and Si precursors can be alcoholate. Suitable materials may also be obtained as natural occurring material, for example clays, which after activation with a mineral acid like HCl, H₂SO₄ or HNO₃ for example acts as a solid acid catalyst.

Suitable catalysts may for example be selected from catalyst obtained by a process which comprises calcining a precursor of an oxide of one or more elements selected from the group consisting of Ge, Sn, B, Al, Ga, Zn, Cu, Fe, Mn, Ni, Cr, Mo, P, S, W, Nb, Ti, Zr, Hf, Y, La, Ce, Yb, and Si at a temperature in the range of from 150 °C to 1150 °C to obtain an oxide; silica-alumina hydrates; a clay compound containing Si and Al; zeolites having a structure selected from the group consisting of BEA, EMT, ERI, EUO, FAU, HEU, LTA, LTL, MAZ, MOR, MTW, NES, OFF and TON; or cation exchange resin.

According to a further embodiment, the present invention therefore is also directed to the process for the preparation of polyacetal polyol as disclosed above, wherein the solid acid catalyst is selected from the group consisting of
catalyst obtained by a process which comprises calcining a precursor of an oxide of one or more elements selected from the group consisting of Ge, Sn, B, Al, Ga, Zn, Cu, Fe, Mn, Ni, Cr, Mo, P, S, W, Nb, Ti, Zr, Hf, Y, La, Ce, Yb, and Si at a temperature in the range of from 150 °C to 1150 °C to obtain an oxide;
silica-alumina hydrates
a clay compound containing Si and Al;
zeolites having a structure selected from the group consisting of BEA, EMT, ERI, EUO, FAU, HEU, LTA, LTL, MAZ, MOR, MTW, NES, OFF and TON;
cation exchange resin;
MOF catalysts.

Particularly suitable are selected from clay compounds, mixed oxides and MOF catalysts.

The process according to the present invention comprises step (i) and may also comprise further steps, in particular purification steps or separation steps. Preferably, the solid catalyst is separated from the reaction mixture after the reaction according to step (i). The catalyst may for example be separated by filtration. The catalyst separated from the reaction mixture might also be subjected to a purification step such as for example a washing step and may also be reused in the process. The process may also comprise further washing steps.

Typically, a reaction mixture is obtained in step (i). The products and also unreacted starting materials such as compounds (D1) and/or (C1) or side products such as cyclic acetals may be separated by suitable separation methods such as for example distillation steps.

According to a further embodiment, the present invention therefore is also directed to the process for the preparation of polyacetal polyol as disclosed above, wherein the process comprises one or more separation steps selected from the group consisting of filtration, distillation and washing.

According to the process of the present invention, polyacetal polyols are obtained. The polyacetal polyols obtained may have one or more acetal groups and OH end groups, for example 1 to 8 OH end groups, preferably 1 to 6, more preferable 1 to 5, 2 to 5, 2 to 4, in particular 2 to 3 OH end groups or 2 OH end groups. Preferably, the molecular weight of the polyacetal polyols is in the range of up to 12.000 g/mol, in particular up to 10.000 g/mol, for example in the range of from 500 to 8.000 g/mol, preferably in the range of from 500 to 8000 g/mol, more preferred in the range of from 800 to 6000 g/mol, in particular in the range of from 1000 to 5000 g/mol, calculated from the OH number according to EN ISO 4629-1:2016. The OH value of the polyacetal polyols may be in the range of from 10 to 1200 mgKOH/g, preferably in the range of from 10 to 600 mgKOH/g, more preferable in the range of from 15 to 500 mgKOH/g, in particular in the range of from 15 to 400 mgKOH/g and the most preferable from 20 to 250 mgKOH/g.

According to a further aspect, the present invention is also directed to the polyacetal polyol obtained or obtainable according to a process for the preparation of polyacetal polyol as disclosed above.

It has been found that the polyacetal polyols according to the present invention are suitable for the preparation of polyurethanes. The resulting polyurethanes can be depolymerized using mild conditions. According to a further aspect, the present invention is also directed to the use of a polyacetal polyol obtained or obtainable according to a process for the preparation of polyacetal polyol as disclosed above or a polyacetal polyol according to the present invention for the preparation of polyurethanes.

Processes for the preparation of polyurethanes are in principle known. Usually, a polyol component is reacted with an isocyanate component.

Typically, polyurethanes are prepared using processes comprising mixing (a) polyisocyanate, (b) a polyol composition comprising polymeric compounds having isocyanate-reactive groups, (c) catalysts and optionally (d) blowing agents, (e) chain-extending and/or crosslinking agents and (f) auxiliaries and/or additives to afford a reaction mixture and reacting the reaction mixture to afford polyurethane. The polyacetal polyols may be used as such or in combination with one or more further polyols.

“Polyurethane” in the context of the invention comprises all known polyisocyanate polyaddition products. These comprise addition products of isocyanate and alcohol and modified polyurethanes which may comprise isocyanurate, allophanate, urea, carbodiimide, uretonimine and biuret structures and further isocyanate addition products. These polyurethanes according to the invention comprise in particular solid polyisocyanate polyaddition products, such as elastomers, thermoplastic PU elastomers, duromers, and foams based on polyisocyanate-polyaddition products, such as flexible foams, semi-rigid foams, rigid foams or integral foams and also polyurethane coatings, adhesives and binders. “Polyurethanes” are further to be understood as meaning polymer blends comprising polyurethanes and further polymers, and also foams made of these polymer blends.

According to a further aspect, the present invention is also directed to a process for preparing a polyurethane at least comprising step (I)
(I) reacting a polyacetal polyol obtained or obtainable according to a process for the preparation of polyacetal polyol as disclosed above or a polyacetal polyol according to the present invention with at least one polyisocyanate.

According to step (I), the polyacetal polyol is brought into contact with at least one polyisocyanate having preferably on average at least 1.5 isocyanate groups which in the following is also referred to as component (a). Further components may be added in the process such as other polymeric compounds having isocyanate-reactive groups (b), catalysts (c), optionally blowing agents (d), chain extenders or cross-linkers (e) and additives (f).

For the purpose of the present invention, principally any polyisocyanate can be employed in step (I). In the context of the present invention, the polyisocyanate (a) is also referred as “isocyanate”. That is to say, the at least one isocyanate comprises a plurality of NCO functional groups, e.g. 2, 3 or 4 NCO functional groups, or any value or ranges of values therein. It is to be understood that the at least one polyisocyanate includes both monomeric diisocyanates, i.e. compounds having 2 NCO functional groups isocyanates, and oligomeric forms thereof having on average more than 2 NCO functional groups, e.g. from 2 to 4 NCO functional groups.

The isocyanates (a) used for producing the polyurethanes according to the invention comprise all polyisocyanates known for the production of polyurethanes. These comprise the aliphatic, cycloaliphatic and aromatic divalent or polyvalent isocyanates known from the prior art and any desired mixtures thereof. Examples include 2,2′-, 2,4′- and 4,4′-diphenylmethane diisocyanate, the mixtures of monomeric diphenylmethane diisocyanates and higher nuclear homologous of diphenylmethane diisocyanate (polymeric MDI), isophorone diisocyanate (IPDI) or its oligomers, 2,4- or 2,6-tolylene diisocyanate (TDI) or mixtures thereof, tetramethylene diisocyanate or its oligomers, pentamethylene diisocyanate, hexamethylene diisocyanate (HDI) or its oligomers, H12-MDI, naphthylene diisocyanate (NDI) or mixtures thereof.

Preference is given to 2,4- and/or 2,6-tolylene diisocyanate (TDI) or mixtures thereof, monomeric diphenylmethane diisocyanates and/or higher nuclear homologous of diphenylmethane diisocyanate (polymeric MDI) and mixtures thereof. Further possible isocyanates are recited for example in “Kunststoffhandbuch”, Volume 7, “Polyurethane”, Carl Hanser Verlag, 3rd edition 1993, chapters 3.2 and 3.3.2.

The isocyanates may be employed in the form of polyisocyanate prepolymers. These polyisocyanate prepolymers are obtainable by reacting an excess of the above-described polyisocyanates (constituent (a)) with polymeric compounds having isocyanate-reactive groups (b) and/or chain extenders (e) for example at temperatures of 20 °C to 100 °C, preferably at about 80 °C, to afford the isocyanate prepolymer.

Polymeric compounds having isocyanate-reactive groups (b) and chain extenders (e) are known to those skilled in the art and described for example in “Kunststoffhandbuch [Plastics Handbook], volume 7, Polyurethane [Polyurethanes]”, Carl Hanser Verlag, 3rd edition 1993, chapter 3.1. Thus, also employable for example as polymeric compounds having isocyanate-reactive groups are the polymeric compounds having isocyanate-reactive groups described below under (b). If an isocyanate prepolymer is employed as isocyanate (a) this preferably has an isocyanate content (NCO content) of more than 5%, more preferably 10% to 45%, yet more preferably 12% to 40%, particularly preferably 15% to 35% and especially 15% to 30% and the most preferably 15% to 25% by weight. Determination of the NCO contents on percent by weight is accomplished by standard chemical titration analysis known to those skilled in the art and, therefore, the present invention is not limited by any such methods.

According to a further embodiment, the present invention is also directed to the process as disclosed above, wherein the isocyanate is selected from the group consisting of aliphatic diisocyanates, alicyclic diisocyanates and aromatic diisocyanates or aromatic/aliphatic oligomeric or polymeric isocyanates.

The term “aliphatic diisocyanate” refers to molecules having two isocyanate groups attached to an acyclic saturated hydrocarbon radical which typically comprises 4 to 18 carbon atoms. Examples of aliphatic diisocyanates include, but are not limited to, tetramethylene-1,4-diisocyanate, pentamethylene-1,5-diisocyanate, hexamethylene 1,6-diisocyanate, decamethylene diisocyanate, 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate, etc., and mixtures thereof. Preferred aliphatic diisocyanates are pentamethylene-1,5-diisocyanate, hexamethylene-1,6-diisocyanate, 2,2,4-trimethyl-hexamethylene-1,6-diisocyanate and 2,4,4-trimethyl-hexamethylene-1,6-diisocyanate, and mixtures thereof.

The term “alicyclic diisocyanate” refers to molecules having two isocyanate groups attached to a saturated hydrocarbon radical bearing at least one cyclic moiety. Alicyclic diisocyanate typically comprises 6 to 18 carbon atoms. Examples of alicyclic diisocyanates include, but are not limited to cyclobutane-1,3-diisocyanate, 1,2-, 1,3- and 1,4-cyclohexane diisocyanate, 2,4- and 2,6-diisocyanato-1-methylcyclohexane (=2,4- and 2,6-hexahydrotoluenediisocyanate), 4,4′- and 2,4′-dicyclohexyldiisocyanates, isocyanatomethylcyclohexane isocyanate, isocyanatoethylcyclohexane isocyanates, bis(isocyanatomethyl)cyclohexane, 4,4′-diisocyanatodicyclohexylmethane (12-MDI), isophorone diisocyanate and mixtures thereof. Preferred alicyclic diisocyanates are 1,2-, 1,3- and 1,4-cyclohexane diisocyanate, 2,4- and 2,6-diisocyanato-1-methylcyclohexane, 4,4′- and 2,4′-dicyclohexyldiisocyanates, bis(isocyanatomethyl)cyclohexane, 4,4′-diisocyanatodicyclohexylmethane (12-MDI), isophorone diisocyanate and mixtures thereof. The isophorone diisocyanate is frequently a mixture, specifically a mixture of the cis and trans isomers, generally in a mass ratio of 60:40 to 80:20, more particularly in a ratio of 70:30 to 75:25, and particularly especially in a ratio of about 75:25.

The term “aromatic diisocyanate”, refers to molecules having two isocyanate groups attached directly and/or indirectly to the aromatic ring. Aromatic diisocyanates typically have 8 to 18 carbon atoms. Examples of aromatic diisocyanates include, but are not limited to, 1,2-, 1,3-, and 1,4-phenylene diisocyanates, naphthylene-1, 5-diisocyanate, 2,4- and 2,6-toluene diisocyanate, 2,4′-, 4,4′- and 2,2′-biphenyl diisocyanates, 2,2′-, 2,4′- and 4,4′-diphenylmethane diisocyanate, 1,2-, 1,3- and 1,4-xylylene diisocyanates and m-tetramethylxylylene diisocyanate (TMXDI), and mixtures thereof. Preferred aromatic diisocyanates are 2,4- and 2,6-toluene diisocyanate, 2,4′-, 4,4′- and 2,2′-biphenyl diisocyanates, 2,2′-, 2,4′- and 4,4′-diphenylmethane diisocyanate, 1,2-, 1,3- and 1,4-xylylene diisocyanates and m-tetramethylxylylene diisocyanate (TMXDI) and mixtures thereof.

The relative amount of the isocyanate composition is preferably chosen such that the molar ratio of NCO groups to isocyanate-reactive groups, i.e. active hydrogen groups present in the polyol composition provided in step (I) may vary depending on the NCO content of the polyurethane to be prepared. Generally, the NCO group content of the obtained product is in the range of from 0.1% and 35% by weight.

According to step (I), polyacetal polyol is reacted with at least one isocyanate. According to the present invention, further compounds typically used for the preparation of polyurethanes may be used. The polyacetal polyol may for example be used in a polyol composition in admixture with further compounds.

A polyol composition (b) may for example comprise the polyacetal polyols according to the present invention in an amount of 1 to 100% by weight based on the composition. Depending on the composition of the polyol composition the features of the polyurethanes obtained may be influenced. According to one embodiment of the present invention, the polyol composition may comprise 50 to 100% by weight based on the composition of the polyacetal polyols. According to an alternative embodiment, the polyol composition may also comprise 1 to 25% by weight based on the composition of the polyacetal polyols.

The polyol composition (b) may also comprise further compounds having at least one functional group comprising active hydrogen reactive towards isocyanate groups.

The term “active hydrogen” refers to compounds having at least one functional group which is capable of reacting with an isocyanate group in an addition reaction, thereby forming a chemical bond between carbon atom of the isocyanate group and one of the atoms of the functional group. These functional groups are also termed “active hydrogen functional group” or “isocyanate reactive group”. Typical active hydrogen functional groups of active hydrogen compounds are the hydroxyl group (OH), the mercapto group (SH), the primary amino group (NH2) and also the secondary amino group (NH). The aforementioned functional groups will react with isocyanate groups to form a urethane, an urea or a thiourethane group, respectively. Preferably, further polyols are used according to the present invention.

Principally, any polyol conventionally used for the preparation of polyurethanes can be used. The type of polyol may depend on the desired purpose of the application. Suitable polyol compounds are polyester polyols, including in particular aliphatic polyester polyols and aliphatic aromatic polyester polyols, polyestercarbonate polyols, polyether-ester polyols, aliphatic polycarbonate polyols, polyacrylate polyols, polyolefine polyols, aliphatic polyetherols and mixtures thereof. In preferred groups of embodiments, the polyol is selected from polyester polyols, in particular aliphatic polyester polyols and aliphatic aromatic polyester polyols, aliphatic polycarbonate polyols, aliphatic polyetherols and mixtures thereof. In particular, the polyol composition comprises a polyester polyol and/or an aliphatic polyether polyol as described herein. Especially, the polyol is selected from polyester polyols, aliphatic polyether polyols and combinations thereof.

Preferably, the polyol has an average molecular weight of less than 10000 g/mol. The molecular weight was determined using ¹H-NMR end group quantification or can be calculated from the OH number according to EN ISO 4629-1:2016.

Polyesterols suitable as polyol are in particular aliphatic polyesterols and aliphatic/aromatic polyesterols, i.e. polyesterols which are based on a dicarboxylic acid component selected from aliphatic dicarboxylic acids, cycloaliphatic dicarboxylic acids, aromatic dicarboxylic acids and combinations and a diol component, selected from aliphatic diols and cycloaliphatic diols and polyetherpolyols.

Suitable aliphatic diols for preparing the polyester polyols generally have usually 2 to 20 C atoms, in particular 3 to 10 C atoms. Examples of aliphatic diols are ethylene glycol, propane-1,2-diol, propane-1,3-diol, butane-1,2-diol, butane-1,3-diol, butane-1,4-diol, butane-2,3-diol, pentane-1,2-diol, pentane-1,3-diol, pentane-1,4-diol, pentane-1,5-diol, pentane-2,3-diol, pentane-2,4-diol, hexane-1,2-diol, hexane-1,3-diol, hexane-1,4-diol, hexane-1,5-diol, hexane-1,6-diol, hexane-2,5-diol, heptane-1,2-diol 1,7-heptanediol, 1,8-octanediol, 1,2-octanediol, 1,9-nonanediol, 1,2-decanediol, 1,10-decanediol, 1,2-dodecanediol, 1,12-dodecanediol, 1,5-hexadiene-3,4-diol, neo-pentyl glycol (2,2-dimethylpropane-1,3-diol), 2,2-diethylpropane-1,3-diol, 2-methyl-2-ethylpropane-1,3-diol, 2-methyl-2,4-pentanediol, 2,4-dimethyl-2,4-pentanediol, 2-ethyl-1,3-hexanediol, 2,5-dimethyl-2,5-hexanediol, 2,2,4-trimethyl-1,3-pentanediol, pinacol, diethylene glycol, triethylene glycol, dipropylene glycol, and tripropylene glycol.

Suitable cycloaliphatic diols for preparing the polyester polyols generally have usually 4 to 20 C atoms, in particular 5 to 10 C atoms. Examples of cycloaliphatic diols are cyclopentanediol, cyclo-hexane-1,4-diol, cyclohexane-1,2-dimethanol, cyclohexane-1,3-dimethanol, cyclohexane-1,4-dimethanol and 2,2,4,4-tetramethylcyclobutane-1,3-diol. Also suitable diols for preparing the poly-ester polyols are polyether diols, in particular polyethylene glycols HO(CH2CH2O)n-H, higher polypropylene glycols HO(CH[CH3]CH2O)n-H, where n is an integer and n≥4, e.g., 4 to 20, and polyethylene-polypropylene glycols, more particularly those having 4 to 20 repeating units, it being possible for the sequence of the ethylene oxide and propylene oxide units to be blockwise or ran-dom, and polytetramethylene glycols, more particularly those having 4 to 20 repeating units, and poly-1,3-propanediols, more particularly those having 4 to 20 repeating units.

Preferred dicarboxylic acids for preparing the polyester polyols are aromatic dicarboxylic acids, such as phthalic acid, isophthalic acid and, terephthalic acid, cycloaliphatic dicarboxylic acids having preferably from 8 to 12 carbon atoms, such as tetrahydrophthalic acid, hexahydrophthalic acid, cyclohexanedicarboxylic acid, and aliphatic dicarboxylic acids having preferably from 3 to 40 carbon atoms, such as malonic acid, succinic acid, 2-methylsuccinic acid, glutaric acid, 2-methylglutaric acid, 3-methylglutaric acid, α-ketoglutaric acid, adipic acid, pimelic acid, azelaic acid, sebacic acid, brassylic acid, fumaric acid, 2,2-dimethylglutaric acid, suberic acid, diglycolic acid, oxaloacetic acid, glutamic acid, aspartic acid, itaconic acid and maleic acid and dimer fatty acids, such as the dimer fatty acid of octadecadienoic acids or dimeric fatty acids obtained by dimerization of other polyunsaturated fatty acids or fatty acid mixtures [CAS 61788-89-4].

The dicarboxylic acid used in preparing the polyester polyols may be the free acids or ester-forming derivatives thereof. Derivatives are understood preferably to be the corresponding anhy-drides, monoalkyl and dialkyl esters, preferably mono- and di-C1-C4 alkyl esters, more preferably monomethyl and dimethyl esters, and also the corresponding monoethyl and diethyl esters, and additionally monovinyl and divinyl esters, and also mixed esters, examples being mixed esters with different C1-C4 alkyl components.

Amongst polyester polyols preference is given to polyester polyols based on a diol component selected from the group consisting of butanediol, neopentyl glycol, hexanediol, ethylene glycol, diethylene glycol and mixtures thereof, and a dicarboxylic acid component selected from the group consisting of adipic acid, phthalic acid, isophthalic acid and combinations thereof. Particular preference is given to polyester polyols based on butanediol and/or neopentyl glycol and/or hex-anediol with adipic acid and/or phthalic acid and/or isophthalic acid.

Polyester polyols suitable as polyol also include polylactones, in particular poly-C4-C12-lactones, especially polycaprolactones (PCL). Polylactones refer to aliphatic polyesters obtainable by ring-opening polymerization of lactones, in particular C4-C12-lactones, especially epsilon-caprolactones (ε-caprolactone). Polycaprolactones have repeating monomer units of the general formula (1) [—O—CHR—(CH2)m-CO—], in which m is 4 to 10, in case of caprolactone m=4, and R is hydrogen. In the context of the invention, the term polycaprolactone is understood to mean both homopolymers of epsilon-caprolactone and copolymers of epsilon-caprolactone. Suitable copoly-mers are, for example, copolymers of epsilon-caprolactone with monomers selected from the group consisting of lactic acid, lactide, hydroxyacetic acid and glycolide. The polyester polyols are customary components which are known e.g. from Ullmanns Encyklopädie der technischen Chemie [Ullmann's Encyclopedia of Industrial Chemistry], 4th edition, volume 19, pp. 62 to 65.

Aliphatic polyether polyols suitable as polyol are, for example, the polyaddition products of C2-C4-alkylene oxides, such as ethylene oxide, propylene oxide, 1,2-butylene oxide, 2,3-butylene oxide or 2-methylpropylene oxide. Further suitable polymeric polyols (b) are aliphatic polyether polyols obtainable by condensation of polyhydric aliphatic alcohols, aliphatic polyether polyols obtained by alkoxylation of aliphatic polyhydric alcohols, amines and amino alcohols. Suitable polyhydric alcohols include ethylene glycol, 1,2-propylene glycol, 1,3-propylene glycol, 1,4-butanediol, neopentyl glycol, 1,6-hexanediol, trimethylolpropane, glycerol, pentaerythritol, triethanolamine (or tris(2-hydroxyethyl)amine), sorbitol or mixtures of these. Suitable polyetherols have generally OH functionalities in the range of 1.5 to 5.0, more preferable in the range of 1.8 to 4 and in particular in the range of 1.8 to 2.5. Suitable polyetherols have preferably OH numbers in the range of 20 to 600 mg KOH/g more preferable 25 to 400 mg KOH/g and in particular in the range of 30 to 250 mg KOH/g. In the context of the present invention, the OH number is measured according to EN ISO 4629-1:2016 unless otherwise noted.

Generally, they have number average molecular weights Mn in the range of 400 to 10.000 g/mol, preferably of 500 to 6.000 g/mol and more preferable 1000 to 3000 g/mol, The molecular weight may be determined using ¹H-NMR spectroscopy end group quantification or can be calculated from the OH number according to EN ISO 4629-1:2016.

Preferred polyether components (b) are polyethylene oxide polyols, polypropylene oxide polyols, polypropylene-polyethylene oxide polyols and polytetramethylene oxide polyols (poly-THF) having a molecular weight Mn of 400 to 10.000 g/mol, preferably of 500 to 6.000 g/mol and more preferable 800 to 3000 g/mol. In this case, the polyether polyols of particularly low molecular weight may be water-soluble in the case of correspondingly high OH contents.

Aliphatic polycarbonate polyols suitable as polyol are obtainable by reaction of carbonic acid derivatives, for example diphenyl carbonate, dimethyl carbonate or phosgene, with diols. Useful diols of this kind include, for example, ethylene glycol, propan-1,2- and -1,3-diol, butane-1,3- and 1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycols, dibutylene glycol, polybutylene glycols, but also lactone-modified diols. The diol component preferably contains 40% to 100% by weight of hexane-1,6-diol and/or hexanediol derivatives, preferably those having ether or ester groups as well as terminal OH groups, for example products which are obtained by reaction of 1 mol of hexanediol with at least 1 mol, preferably 1 to 2 mol, of ε-caprolactone or by etherification of hexanediol with itself to give di- or tri-hexylene glycol. It is also possible to use polyether polycarbonate polyols. Amongst aliphatic polycarbonate polyols preference is given to polycarbonate polyols based on dimethyl carbonate and hexanediol and/or butanediol and/or ε-caprolactone. Very particular preference is given to polycarbonate polyols based on dimethyl carbonate and hexanediol and/or ε-caprolactone. Preferred polycarbonate polyols have a molecular weight Mn of 400 to 10.000 g/mol, preferably of 500 to 5.000 g/mol, determined by gel permeation chromatography as described above.

Further compounds may be added in step (I), which may for example one or more further active hydrogen compounds, also summarized as chain extenders and/or crosslinkers (e) in the following. Generally, said active hydrogen compounds have a molecular weight of at most 500 g/mol. Suitable active hydrogen compounds may have 2, 3 or 3 and preferably have 2 functional groups capable of reacting with the isocyanate group, which are in particular selected from OH, NH₂ or SH. In particular, suitable compounds are selected compounds having a molecular weight of at most 400 g/mol and having 2 OH groups per molecule as sole functional groups.

In particular, the active hydrogen compounds may be selected from aliphatic diol compounds having 2 to 20 carbon atoms, for example ethylene glycol, 1,2-propanediol, 1,3-propanediol, 1,1-dimethylethane-1,2-diol, 2-butyl-2-ethyl-1,3-propanediol, 2-ethyl-1,3-propanediol, 2-methyl-1,3-propanediol, neopentyl glycol, hydroxypivalic acid neopentyl glycol ester, 1,2-, 1,3- and 1,4-butanediol, 1,6-hexanediol, 1,10-decanediol, 2-ethyl-1,3-hexanediol, 2,4-diethyloctane-1,3-diol, cyclic aliphatic diol compounds having 3 to 14 carbon atoms, for example tetramethylcyclobutanediol, 1,2-, 1,3- and 1,4-cyclohexanediol, 1,1-, 1,2-, 1,3- and 1,4-cyclohexanedimethanol, 1,2-, 1,3- or 1,4-cyclooctanediol, norbornanediol, pinanediol, decalindiol, 2,2-bis(4-hydroxycyclohexyl)propane, bis(4-hydroxycyclohexane)isopropylidene; and aliphatic aminoalco-hols having 2 to 20 carbon atoms, such as monoethanolamine, diethanolamine, monopropanolamine, dipropanolamine, N-methyl diethanolamine and N-methyl dipropanolamine.

Particular preference is given to compounds which are selected from aliphatic diols having 2 to 12 carbon atoms such as ethylene glycol, 1,4-butanediol, 1,5-pentanediol and 1,6-hexanediol.

Chain extenders with acetal groups may also be used according to the present invention.

In the context of the present invention, also compounds having a molecular weight of at most 500 g/mol and having 3 or more OH groups per molecule as sole functional groups may be used as cross-linkers (e). Also cross-linkers having acetal groups may be used according to the present invention. Suitable compounds are for example glycerol, and trimethylolpropane.

Further additives and/or auxiliaries may be used as component (f). Preferably, the liquid mixture of polyol compounds provided in step (I) contains less 10% of organic compounds which do not have any active hydrogen functional groups and which thus are inert under reaction conditions. These compounds typically have a molecular weight of at most 200 g/mol and are also termed “organic solvent”. Examples of organic solvents include, but are not limited to, ketones having 3 to 8 carbon atoms, in particular aliphatic or cycloaliphatic ketones having 3 to 8 carbon atoms, such as acetone, methylethyl ketone, cyclohexanone and isobutylme-thyl ketone, and aliphatic or alicyclic ethers, e.g. tetrahydrofurane, dioxane or di-C1-C4-alkyl ethers of mono-, di or trialkylene glycols, such as diethyleneglycol dimethyl ether, triethyleneglycol dimethyl ether, dipropyleneglycol dimethyl ether, tripropyleneglycol dimethyl ether, esters, e.g. C4-C8 lactones, such as butyrolactone, valerolactone or caprolactone, aliphatic etheresters, e.g. C1-C4 alkoxy-C2-C4 alkyl acetates and propionates, such as methoxypropyl acetate, or carbonates, such as ethylene carbonate, dimethyl carbonate, diethyl carbonate, N-alkyl-2-pyrrolidones, such as N-methyl-2-pyrrolidone, N-ethyl-2-pyrrolidone or higher homologues, and mixtures thereof. In particular, the liquid mixture of polyol compounds provided in step (I) does not contain any organic compound which does not have any active hydrogen functional group or contains less 2% by weight of said compounds, more preferably less 1% by weight of said compounds, in particular less 0.5% by weight of said compounds.

The liquid mixture may contain further components, such as for example a catalyst (c) which catalyzes the polyurethane formation of the reactive components contained in the liquid mixture with the isocyanate compound. The amount of catalyst will be typically not exceed 5% by weight, based on the total weight of the liquid mixture and is typically in the range of 0.1 to 3% by weight. Suitable catalysts include, but not limited to, tin compounds such as tin octoate, dibutyltin dilaurate, bismuth neodecanoate or bismuth dioctoate, and tertiary amines such as dimethylbenzylamine, trimethylamine, 1,4-diazabicyclo[2.2.2]octane or any other catalyst known to the person skilled in the art which furthers the formation of urethane groups by the reaction of the hydroxyl groups in compounds (b) and (e) with the isocyanate groups of the isocyanate compound (a). Further catalysts are described in, for example, Houben-Weyl, Methoden der Organischen Chemie, Vol. XIV/2, Thieme-Verlag, Stuttgart 1963, p. 60f. and also Ullmanns Enzyklopädie der Technischen Chemie, 4th ed., Vol. 19 (1981), p. 306.

Typical catalysts (c) employable for production of polyurethanes include for example amidines, such as 2,3-dimethyl-3,4,5,6-tetrahydropyrimidine, tertiary amines, such as triethylamine, tributylamine, dimethylbenzylamine, N-methyl-, N-ethyl- and N-cyclohexylmorpholine, N,N,N′,N′-tetramethylethylenediamine, N,N,N′,N′-tetramethylbutanediamine, N,N,N′,N′-tetramethylethylenediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane and preferably 1,4-diazabicyclo[2.2.2]octane, and alkanolamine compounds such as triethanolamine, triisopropanolamine, N-methyl- and N-ethyldiethanolamine and dimethylethanolamine. Examples of incorporable catalysts that may be used are bis(dimethylaminopropyl)urea, bis(N,N-dimethylaminoethoxyethyl) carbamate, dimethylaminopropylurea, N,N,N-trimethyl-N-hydroxyethylbis(aminopropylether), N,N,N-trimethyl-N-hydroxyethylbis(aminoethylether), diethylethanolamine, bis(N,N-dimethyl-3-aminopropyl)amine, dimethylaminopropylamine, 1-(3-aminopropyl)pyrrolidine, 3-dimethylaminopropyl-N, N-dimethylpropane-1,3-diamine, dimethyl-2-(2-aminoethoxyethanol), (1,3-bis(dimethylamino)propan-2-ol), N,N-bis(3-dimethylaminopropyl)-N-isopropanolamine, bis(dimethylaminopropyl)-2-hydroxyethylamine, N,N,N-trimethyl-N-(3-aminopropyl)bis(aminoethylether), 1,4-diazabicyclo[2.2.2]octane-2-methanol and 3-dimethylaminoisopropyl diisopropanolamine or mixtures thereof. Likewise contemplated are organic metal compounds, preferably organic tin compounds, such as tin(II) salts of organic carboxylic acids, for example tin(II) acetate, tin(II) octoate, tin(II) ethylhexoate and tin(II) laurate, and the dialkyltin(IV) salts of organic carboxylic acids, for example dibutyltin diacetate, dibutyltin dilaurate, dibutyltin maleate and dioctyltin diacetate, and also bismuth carboxylates, such as bismuth(II) neodecanoate, bismuth 2-ethylhexanoate and bismuth octanoate, or mixtures thereof. The organic metal compounds may be used either alone or preferably in combination with strongly basic amines.

The polyurethane obtained according to the process may be a compact material which may for example be used as an adhesive. The polyurethane may also be a polyurethane foam.

When the polyurethane according to the invention is to be in the form of a polyurethane foam, reaction mixtures according to the invention further comprise blowing agent (d). Any blowing agents known for the production of polyurethanes may be employed. These may comprise chemical and/or physical blowing agents. Such blowing agents are described in, for example, “Kunststoffhandbuch [Plastics Handbook], volume 7, Polyurethane [Polyurethanes]”, Carl Hanser Verlag, 3rd edition 1993, chapter 3.4.5. “Chemical blowing agents” is understood to mean compounds that form gaseous products by reaction with isocyanate. Examples of such blowing agents are water or carboxylic acids. “Physical blowing agents” is understood to mean compounds that are dissolved or emulsified in the input materials of polyurethane production and vaporize under the conditions of polyurethane formation. Examples thereof include hydrocarbons, halogenated hydrocarbons and other compounds, for example perfluorinated alkanes such as perfluorohexane, chlorofluorohydrocarbons, and ethers, esters, ketones, acetals and/or liquid carbon dioxide. The blowing agent may be employed in any desired amount The blowing agent is preferably employed in an amount such that the resulting polyurethane foam has a density of 10 to 850 g/L, particularly preferably 20 to 800 g/L and in particular 25 to 500 g/L. It is particularly preferable to employ blowing agents comprising water.

Further auxiliaries and/or additives (f) may also be employed. Any auxiliary and additive substances known for the production of polyurethanes may be used. Examples include surface-active substances, foam stabilizers, cell regulators, release agents, fillers, dyes, pigments, flame retardants, hydrolysis stabilizers, fungistatic and bacteriostatic substances and also antioxidants. Such substances are known and described for example in “Kunststoffhandbuch, volume 7, Polyurethane”, Carl Hanser Verlag, 3rd edition 1993, chapters 3.4.4 and 3.4.6 to 3.4.11.

Step (I) generally comprises mixing the compounds and heating the thus obtained mixture until the compounds are mutually dissolved in each other. Mixing and heating can be done simultaneously or consecutively. Suitable conditions depending on the components used and the material prepared are in principle known to the person skilled in the art.

Mixing may for example be carried out at room temperature but may also be carried out at elevated temperatures, e.g. at a temperature of at least 50 °C, in particular at a temperature in the range of 50 to 150 °C.

The reaction conditions for polyurethane formation will depend on the reactivity of the components present in the polyol composition, the reactivity of the isocyanate and the presence or absence of a catalyst.

Preferably, step (I) is carried out at least initially in the absence of an organic solvent having no hydrogen active groups. Therefore, the amount of organic solvent, i.e. organic compounds which do not have any active hydrogen functional group and a molecular weight of at most 200 g/mol in the reactants fed to the reactor is preferably less than 1% by weight, based on the total weight of reactants fed to the reactor, in particular less than 0.1% by weight or zero. However, it is also possible to use solvents such as acetone depending on the reaction conditions and the components used in the process.

According to a further aspect, the present invention is also directed to the polyurethane obtained or obtainable according to a process for preparing a polyurethane as disclosed above.

According to a further aspect, the present invention is also directed to a process for recycling a polyurethane obtained according to a process as disclosed above or a polyurethane according to the present invention, at least comprising the step
(x) treating the polyurethane with a solution at a pH in the range of 0 to 6.

Accordingly, in one embodiment, the present invention is directed to a process for recycling a polyurethane material. Specifically, the process comprises: contacting the polyurethane material with an acid solution and allowing at least a portion of the polyurethane material to decompose into a recovered raw material composition.

The acid aqueous solution that is used in the process can comprise any acid compound provided that it has a pH of less than or equal to about 6, preferably of less than 4, in particular less than 2. In certain embodiments, the acid solution may comprise other components in addition to the acid compound. These components can include solvents such as alcohols, THF, toluene, or further solvents.

The process may also comprise further steps, in particular further steps after step (x). It is for example possible that one or more of the following steps are carried out:
separation of obtained liquid phase and solid hard phase, optionally also separation of a resulting gas phase;
neutralization of acidic liquid phase using base or ion exchange resin;
separation of water and the components obtained using distillation, precipitation, or extraction;
depolymerization of solid hard phase using for example hydrolysis, for example at a pH of greater than 7, in particular a pH of greater than 10, for example in 1-methylimidazole, or in the presence of strong base such as KOH, NaOH, tBuOK, organic base such as TBD, DBU, DABCO, DMAP, etc., or organic salts based on such bases, e.g. DBU-acetate. Suitable conditions are for example disclosed in WO 2010/130652 A2;
separation of water and the components obtained using distillation, precipitation, or extraction.

According to one embodiment, all steps are carried out to separate the components obtained.

Suitable acids for step (x) are generally inorganic and organic acids. Examples of inorganic acids are hydrochloric acid, nitric acid, sulfuric acid, phosphoric acid, boric acid, hydrobromic acid, Examples of organic acids are oxalic acid, formic acid, acetic acid, citric acid, benzoic acid, dicarboxylic acids such as adipic acid, glutaric acid or succinic acid, methanesulfonic acid and p-toluolsulfonic acid.

While it is desirable to submerge the entire polyurethane material to be decomposed into the acid solution, there are embodiments where only a portion of the polyurethane material is contacted with the acid solution. In these embodiments, the remaining portion of the polyurethane material (i.e. the portion that does not contact the acid solution) will not be decomposed. In other words, partial recycling of a polyurethane material is also contemplated by the present disclosure.

There are also a variety of ways to promote the depolymerization process and, ultimately, the decomposition of the polyurethane material into the various components comprising the recovered raw material composition. Usually, the polyurethane is comminuted using suitable methods such as cutting or grinding prior to depolymerization. Usually, once submerged in the acid solution, the polyurethane material may be agitated using techniques known in the art. Additionally, heat may be applied to one or both the acid solution and the polyurethane material to facilitate the depolymerization process. For example, the acid solution in which the polyurethane material is submerged may be heated to a temperature ranging from 60 °C to 100 °C. Only if necessary, material may be heated to a temperature above 100 °C, e.g. from 100-200 °C. The total amount of time needed to decompose the polyurethane material into the recovered raw material composition may vary depending on a number of factors, such as the thickness of the polyurethane material.

The process may comprise further steps such as separation steps separating obtained liquid and solid phase or neutralization and purification steps, for example by distillation, precipitation or extraction. Residues for example remaining parts of the hardphase of the polyurethane may be treated in a separate recycling step, for example by treating the residues with a solution, for example a basic solution. For example, the base solution in which the hard phase is submerged may be heated to a temperature ranging from 60 °C to 200 °C. In certain embodiments, the base solution may comprise other components in addition to the base compound. These components can include solvents such as alcohols, THF, toluene or further solvents.

The recovered materials, such as a recovered diol compound can then be used as a raw material to prepare the virgin original polyol or other materials.

The process of the present disclosure enables the conversion of certain polyurethane materials into a raw material compound that can be used as a reactive ingredient in the preparation of original virgin polyols or preparation of another material, such as another type of polyurethane material or another polymer type. This process of recycling the original polyurethane material is energy efficient and can lead to a significant decrease in the total amount of polyurethane materials ending up in a land fill.

Further embodiments of the present invention can be found in the claims and the examples. It will be appreciated that the features of the subject matter/processes/uses according to the invention that are mentioned above and elucidated below are usable not only in the combination specified in each case but also in other combinations without departing from the scope of the invention. For example, the combination of a preferred feature with a particularly preferred feature or of a feature not characterized further with a particularly preferred feature etc. is thus also encompassed implicitly even if this combination is not mentioned explicitly.

Illustrative embodiments of the present invention are listed below, but these do not restrict the present invention. In particular, the present invention also encompasses those embodiments which result from the dependency references and hence combinations specified hereinafter.
1. Process for the preparation of polyacetal polyol comprising the step (i) of reacting a compound (D1) having at least one OH group with a compound (C1) in the presence of a solid acid catalyst, wherein the compound (C1) is selected from the group consisting of vinylethers, aldehydes and acetals.
2. The process according to embodiment 1, wherein compound (D1) has a molecular weight of less than 5000 g/mol, preferably less than 2000 g/mol, in particular less than 1000 g/mol, more preferable less than 500 g/mol.
3. The process according to embodiment 1 or 2, wherein compound (D1) has a functionality of from 1 to 8, preferably from 2 to 3.
4. The process according to any one of embodiments 1 to 3, wherein the reaction according to step (i) is a polyaddition, polycondensation or transacetalization
5. The process according to any one of embodiments 1 to 4, wherein the solid acid catalyst is selected from the group consisting of
   catalyst obtained by a process which comprises calcining a precursor of an oxide of one or more elements selected from the group consisting of Ge, Sn, B, Al, Ga, Zn, Cu, Fe, Mn, Ni, Cr, Mo, P, S, W, Nb, Ti, Zr, Hf, Y, La, Ce, Yb, and Si at a temperature in the range of from 150 °C to 1150 °C to obtain an oxide;
   silica-alumina hydrates
   a clay compound containing Si and Al;
   zeolites having a structure selected from the group consisting of BEA, EMT, ERI, EUO, FAU, HEU, LTA, LTL, MAZ, MOR, MTW, NES, OFF and TON;
   cation exchange resin;
   MOF catalysts.
6. The process according to any one of embodiments 1 to 5, wherein the compound (D1) is selected from the group consisting of monools, diols, and triols with 1 to 20 C-atoms, preferably from the group consisting of monools, diols and triols with 2 to 6 C-atoms.
7. The process according to any one of embodiments 1 to 6, wherein compound (C1) is selected from the group consisting of divinyl ethers and mono vinyl ethers.
8. The process according to any one of embodiments 1 to 6, wherein compound (C1) is selected from the group consisting of linear aliphatic aldehydes, branched aliphatic aldehydes, aromatic aldehydes, and ketones.
9. The process according to any one of embodiments 1 to 6, wherein compound (C1) is selected from the group consisting of aliphatic acetals, aromatic acetals, and ketals.
10. The process according to any one of embodiments 1 to 9, wherein the process comprises one or more separation steps selected from the group consisting of filtration, distillation and washing.
11. Polyacetal polyol obtained or obtainable according to a process according to any one of embodiments 1 to 10.
12. Polyacetal polyol according to embodiment 11, wherein the polyacetal polyol has at least one acetal group and 1 to 8 OH end groups.
13. Polyacetal polyol according to embodiment 11 or 12, wherein the polyacetal polyol has an OH value in the range of from 10 to 1200 mgKOH/g.
14. Polyacetal polyol obtained or obtainable according to a process comprising the step (i) of reacting a compound (D1) having at least one OH group with a compound (C1) in the presence of a solid acid catalyst, wherein the compound (C1) is selected from the group consisting of vinylethers, aldehydes and acetals.
15. The polyacetal polyol according to embodiment 14, wherein compound (D1) has a molecular weight of less than 5000 g/mol, preferably less than 2000 g/mol, in particular less than 1000 g/mol, more preferable less than 500 g/mol.
16. The polyacetal polyol according to embodiment 14 or 15, wherein compound (D1) has a functionality of from 1 to 8, preferably from 2 to 3.
17. The polyacetal polyol according to any one of embodiments 14 to 16, wherein the reaction according to step (i) is a polyaddition, polycondensation or transacetalization
18. The polyacetal polyol according to any one of embodiments 14 to 17, wherein the solid acid catalyst is selected from the group consisting of
   catalyst obtained by a process which comprises calcining a precursor of an oxide of one or more elements selected from the group consisting of Ge, Sn, B, Al, Ga, Zn, Cu, Fe, Mn, Ni, Cr, Mo, P, S, W, Nb, Ti, Zr, Hf, Y, La, Ce, Yb, and Si at a temperature in the range of from 150 °C to 1150 °C to obtain an oxide;
   silica-alumina hydrates
   a clay compound containing Si and Al;
   zeolites having a structure selected from the group consisting of BEA, EMT, ERI, EUO, FAU, HEU, LTA, LTL, MAZ, MOR, MTW, NES, OFF and TON;
   cation exchange resin;
   MOF catalysts.
19. The polyacetal polyol according to any one of embodiments 14 to 18, wherein the compound (D1) is selected from the group consisting of monools, diols, and triols with 1 to 20 C-atoms, preferably from the group consisting of monools, diols and triols with 2 to 6 C-atoms.
20. The polyacetal polyol according to any one of embodiments 14 to 19, wherein compound (C1) is selected from the group consisting of divinyl ethers and mono vinyl ethers.
21. The polyacetal polyol according to any one of embodiments 14 to 20, wherein compound (C1) is selected from the group consisting of linear aliphatic aldehydes, branched aliphatic aldehydes, aromatic aldehydes, and ketones.
22. The polyacetal polyol according to any one of embodiments 14 to 19, wherein compound (C1) is selected from the group consisting of aliphatic acetals, aromatic acetals, and ketals.
23. The polyacetal polyol according to any one of embodiments 14 to 22, wherein the process comprises one or more separation steps selected from the group consisting of filtration, distillation and washing.
24. Use of a polyacetal polyol obtained or obtainable according to a process according to any one of embodiments 1 to 10 or a polyacetal polyol according to any one of embodiments 11 to 23 for the preparation of polyurethanes.
25. Process for preparing a polyurethane at least comprising step (I)
   (I) reacting a polyacetal polyol obtained or obtainable according to a process according to any one of embodiments 1 to 10 or a polyacetal polyol according to any one of embodiments 11 to 23 with at least one isocyanate.
26. Polyurethane obtained or obtainable according to a process according to embodiment 25.
27. Process for recycling a polyurethane obtained according to a process according to embodiment 15 or a polyurethane according to embodiment 26, at least comprising the step
   (x) treating the polyurethane with a solution at a pH in the range of 0 to 6.
28. The process according to embodiment 27, wherein the process comprises one or more of the following steps:
   separation of obtained liquid phase and solid hard phase, optionally also separation of a resulting gas phase;
      neutralization of acidic liquid phase using base or ion exchange resin;
   separation of water and the components obtained using distillation, precipitation, or extraction.
29. Process for the preparation of polyacetal polyol comprising the step (i) of reacting a compound (D1) having at least one OH group with a compound (C1) in the presence of a solid acid catalyst, wherein the compound (C1) is selected from the group consisting of vinylethers, aldehydes and acetals, wherein the catalyst s solid under the reaction conditions of step (i).
30. Process for the preparation of polyacetal polyol comprising the step (i) of reacting a compound (D1) having at least one OH group with a compound (C1) in the presence of a solid acid catalyst, wherein the compound (C1) is selected from the group consisting of vinylethers, aldehydes and acetals, wherein the solid acid catalyst is selected from the group consisting of
   catalyst obtained by a process which comprises calcining a precursor of an oxide of one or more elements selected from the group consisting of Ge, Sn, B, Al, Ga, Zn, Cu, Fe, Mn, Ni, Cr, Mo, P, S, W, Nb, Ti, Zr, Hf, Y, La, Ce, Yb, and Si at a temperature in the range of from 150 °C to 1150 °C to obtain an oxide;
   silica-alumina hydrates
   a clay compound containing Si and Al;
   zeolites having a structure selected from the group consisting of BEA, EMT, ERI, EUO, FAU, HEU, LTA, LTL, MAZ, MOR, MTW, NES, OFF and TON;
   cation exchange resin;
   MOF catalysts.
31. The process according to claim 29 or 30, wherein compound (D1) has a molecular weight of less than 5000 g/mol, preferably less than 2000 g/mol, in particular less than 1000 g/mol, more preferable less than 500 g/mol.
32. The process according to any one of claims 29 to 31 wherein compound (D1) has a functionality of from 1 to 8, preferably from 2 to 3.
33. The process according to any one of claims 29 to 32, wherein the reaction according to step (i) is a polyaddition, polycondensation or transacetalization
34. The process according to any one of claims 29 to 33, wherein the solid acid catalyst is selected from the group consisting of
   catalyst obtained by a process which comprises calcining a precursor of an oxide of one or more elements selected from the group consisting of Ge, Sn, B, Al, Ga, Zn, Cu, Fe, Mn, Ni, Cr, Mo, P, S, W, Nb, Ti, Zr, Hf, Y, La, Ce, Yb, and Si at a temperature in the range of from 150 °C to 1150 °C to obtain an oxide;
   silica-alumina hydrates
   a clay compound containing Si and Al;
   zeolites having a structure selected from the group consisting of BEA, EMT, ERI, EUO, FAU, HEU, LTA, LTL, MAZ, MOR, MTW, NES, OFF and TON;
   cation exchange resin;
   MOF catalysts.
35. The process according to any one of claims 29 to 34, wherein the compound (D1) is selected from the group consisting of monools, diols, and triols with 1 to 20 C-atoms, preferably from the group consisting of monools, diols and triols with 2 to 6 C-atoms.
36. The process according to any one of claims 29 to 35, wherein compound (C1) is selected from the group consisting of divinyl ethers and mono vinyl ethers.
37. The process according to any one of claims 29 to 36, wherein compound (C1) is selected from the group consisting of linear aliphatic aldehydes, branched aliphatic aldehydes, aromatic aldehydes, and ketones.
38. The process according to any one of claims 29 to 37, wherein compound (C1) is selected from the group consisting of aliphatic acetals, aromatic acetals, and ketals.
39. The process according to any one of claims 29 to 38, wherein the process comprises one or more separation steps selected from the group consisting of filtration, distillation and washing.
40. Polyacetal polyol obtained or obtainable according to a process according to any one of claims 29 to 39.
41. Polyacetal polyol according to claim 40, wherein the polyacetal polyol has at least one acetal group and 1 to 8 OH end groups.
42. Polyacetal polyol according to claim 40 or 41, wherein the polyacetal polyol has an OH value in the range of from 10 to 1200 mgKOH/g.
43. Use of a polyacetal polyol obtained or obtainable according to a process according to any one of claims 29 to 39 or a polyacetal polyol according to any one of claims 40 to 42 for the preparation of polyurethanes.
44. Process for preparing a polyurethane at least comprising step (I)
   (I) reacting a polyacetal polyol obtained or obtainable according to a process according to any one of claims 29 to 39 or a polyacetal polyol according to claim 11 with at least one isocyanate.
45. Polyurethane obtained or obtainable according to a process according to claim 44.
46. Process for recycling a polyurethane obtained according to a process according to claim 44 or a polyurethane according to claim 45, at least comprising the step
   (x) treating the polyurethane with a solution at a pH in the range of 0 to 6.
47. The process according to claim 46, wherein the process comprises one or more of the following steps:
   separation of obtained liquid phase and solid hard phase, optionally also separation of a resulting gas phase;
   neutralization of acidic liquid phase using base or ion exchange resin;
   separation of water and the components obtained using distillation, precipitation, or extraction.

The invention is further described by examples. The examples relate to practical and in some cases preferred embodiments of the invention that do not limit the scope of the invention.

### EXAMPLES

### I. Materials Used

### 1. Catalysts

1.1 Siral 70, (mixed oxide/hydroxide of silica and alumina (with the ratio of Al2O3/SiO2 of 30/70) obtained from Sasol (Germany)

| | |
|---|---|
| Specific surface area by nitrogen sorption S_{BET} [m²/g] | 375 |
| Acidity by ammonia TPD: Amount [mmol/g] | 0.70 |
| Acidity by ammonia TPD: Tₘₐₓ [°C] | 202 and 362 |

1.2 K10, alumosilicate catalyst, acid activated natural bentonite clay, obtained from Clariant (Germany)

| | |
|---|---|
| Specific surface area by nitrogen sorption S_{BET} [m²/g] | 236 |
| Acidity by ammonia TPD: Amount [mmol/g] | 0.24 |
| Acidity by ammonia TPD: Tₘₐₓ [°C] | 194 and 360 |

1.3 Basolite C-300: MOF (Copper benzene-1,3,5-tricarboxylate) provided by BASF SE (Germany)

| | |
|---|---|
| Specific surface area by nitrogen sorption S_{BET} [m²/g] | 1500-2100 |
| Particle size distribution (D50) [μm] | 15.96 |

### II. Examples

### 1. Polyacetal Polyol 1

1,4-Butanediol (B14) and 1,4-butanediol divinyl ether (B14 DVE) were dried for at least 48 hours using molecular sieves prior to use. 85.4 g of the dried 1,4-butanediol were added into a 500 ml three neck round bottom flask equipped with an argon inlet, a mechanical stirrer, thermocouple and an addition funnel. 2.4 g K10 catalyst were added to the B14. The reaction mixture was heated to 30 °C and the mechanical stirrer was set to 450 rpm to fully suspend the catalytic particles in the reaction mixture. The addition funnel was charged with 114.8 g B14 DVE. The B14 DVE was added dropwise into the reaction mixture, after approximately 30 minutes the addition was completed. The reaction temperature was kept constant at 30 °C. After a total reaction time of 90 minutes the polyaddition was finished. The reaction mixture was vacuum filtered to remove the solid catalyst and the filtered solution was then dried with a rotary evaporator for 2 hours at 65 °C under reduced pressure (18 mbar). The resulting product is a clear colorless polyacetal polyol with an OH value of 116.9 mg KOH/g and an acid value below 0.1 mg KOH/g.

The K10 catalyst removed via filtration was washed with diethyl ether and dried in a nitrogen oven at 50 °C. Subsequently, the catalyst could be reused for at least two more reactions, yielding polyacetal polyols with similar OH and acid values as the original polyol described above.

### 2. Polyacetal Polyol 2

1,4-Butanediol (B14) and 1,4-butanediol divinyl ether (B14 DVE) were dried for at least 48 hours using molecular sieves prior to use. About 367 g of the dried 1,4-butanediol were added into a 1 l three neck round bottom flask fitted with an argon inlet, a mechanical stirrer, thermocouple and an addition funnel. 19.1 g of Siral 70 catalyst were added to the B14. The reaction mixture was heated to 30 °C and the mechanical stirrer was set to 450 rpm to fully suspend the catalytic particles in the reaction mixture. The addition funnel was charged with 573 g B14 DVE. The B14 DVE was added dropwise into the reaction mixture, after approximately 60 minutes the addition was completed. The reaction temperature was maintained at 30 °C. After a total reaction time of 6 hours the polyaddition was finished. The reaction mixture was vacuum filtered to remove the solid catalyst. The filtered solution was then dried with a rotary evaporator for 4 hours at 65 °C under reduced pressure (18 mbar). The resulting product is a clear colorless polyacetal polyol with an OH value of 58 mgKOH/g and an acid value of 0.03 mgKOH/g.

The Siral 70 catalyst removed via filtration was washed with diethyl ether and dried in a nitrogen oven at 50 °C. Subsequently, the catalyst could be reused for at least four more reactions, yielding polyacetal polyols with similar OH and acid values as the original polyol described above.

### 3. Polyacetal Polyol 3

Diethylene glycol divinylether (DEG DVE) was dried for at least 48 hours using molecular sieves prior to use. 101 g of 1,6-hexanediol (H16) were added into a 500 ml three neck round bottom flask equipped with an argon inlet, a mechanical stirrer, thermocouple and an addition funnel. 3 g of K10 catalyst were added to the H16. The reaction mixture was heated to 45 °C in order to melt the H16 and the mechanical stirrer was set to 450 rpm to suspend the catalytic particles in the reaction mixture. The addition funnel was charged with 110.1 g DEG DVE. The DEG DVE was added dropwise, after approximately 15 minutes the addition was completed. During the addition of DEG DVE the reaction temperature was slowly decreased from 45 to 30 °C after which it was maintained at 30 °C. After a total reaction time of 3 hours the polyaddition was finished. The reaction mixture was vacuum filtered in order to remove the solid catalyst and the filtered solution was then dried with a rotary evaporator for 2 hours at 65 °C under reduced pressure (18 mbar). The resulting product is a clear colorless polyacetal polyol with an OH value of 97 mg KOH/g and an acid value below 0.1 mg KOH/g.

### 4. Polyacetal Polyol 4

80 g of 1,6-hexanediol (H16) were added into a 250 ml three neck round bottom flask equipped with an argon inlet, dean stark trap, and a thermocouple. 5.8 g of Siral 70 catalyst and 30 g of paraldehyde were added. 20 g of hexane were added as the water carrying agent for the dean stark trap. The reaction mixture was heated to 75 °C, with the magnetic stirrer set at 450 rpm to suspend the catalytic particles in the reaction mixture. After a reaction time of 22 hours the polycondensation was finished, with all acetaldehyde being consumed. The reaction mixture was vacuum filtered in order to remove the solid catalyst, the filtered product was then dried with a rotary evaporator for 2 hours at 65 °C under reduced pressure (18 mbar). The resulting product is a clear colorless polyacetal polyol with an OH value of 153 mg KOH/g and an acid value of 0.01 mg KOH/g.

### 5. Polyacetal Polyol 5

45 g of 1,6-hexanediol (H16) were added into a 250 ml three neck round bottom flask equipped with an argon inlet, dean stark trap, and a thermocouple. 2.57 g of Basolite C300 MOF catalyst and 30 g of benzaldehyde were added. 20 g of hexane were added as the water carrying agent for the dean stark trap. The reaction mixture was heated to 77 °C, with the magnetic stirrer set at 450 rpm to suspend the catalytic particles in the reaction mixture. After a reaction time of 16 hours the reaction mixture was vacuum filtered in order to remove the solid catalyst The polyol was then dried with a rotary evaporator for 2 hours at 65 °C and 2 hours at 110 °C under reduced pressure (10 mbar). The resulting product is a clear colorless polyacetal polyol with an OH value of 76 mg KOH/g and an acid value of 0.07 mg KOH/g.

### 6. Polyacetal Polyol 6

64 g of 1,6-hexanediol (H16) were added into a 250 ml round bottom flask. 1.85 g of K10 catalyst and 89 g of 1,1-diethoxypropane were added. The flask was connected to a rotary evaporator heated to 60 °C at a pressure of 750 mbar for 1 h. Subsequently, the pressure was decreased every hour first to 450 mbar, then to 250 mbar and finally to 20 mbar. After 20 hours the reaction mixture was vacuum filtered in order to remove the solid catalyst. The filtered product was then dried with a rotary evaporator for 2 hours at 65 °C under reduced pressure (18 mbar). The resulting product is a transparent polyacetal polyol with an OH value of 76 mg KOH/g and an acid value of 0.04 mg KOH/g.

### 7. Polyacetal Polyol 7

Diethylene glycol divinylether (DEG DVE) was dried for at least 48 hours using molecular sieves prior to use. 120 g of 1,6-hexanediol (H16) and 17 g of trimethylolpropane were added into a 500 ml three neck round bottom flask equipped with an argon inlet, a mechanical stirrer, thermocouple and an addition funnel. 3.6 g of K10 catalyst were added to the mixture. The mechanical stirrer was set to 450 rpm to suspend the catalytic particles in the reaction mixture, and the reaction mixture was heated to 50 °C. The addition funnel was charged with 161 g of DEG DVE. The DEG DVE was added dropwise, after approximately 15 minutes the addition was completed. During the addition of DEG DVE the reaction temperature was slowly decreased from 50 to 30 °C and maintained at 30 °C. After a total reaction time of 22 hours, the reaction mixture was vacuum filtered in order to remove the solid catalyst and the filtered solution was then dried with a rotary evaporator for 2 hours at 65 °C under reduced pressure (18 mbar). The resulting product is a clear colorless polyacetal polyol with an OH value of 83 mg KOH/g and an acid value below 0.1 mg KOH/g.

### 8. Acetal Containing Chain Extender

72 g of 1,1-diethoxypropane were added into a 250 ml round bottom flask. 2.42 g of K10 catalyst and 50.5 g of 2-hydroxyethyl acetate (60% purity purchased from TCI Europa) were added. The flask was fitted to a rotary evaporator heated to 55 °C at a pressure of 750 mbar for 1 h. Subsequently, the pressure was decreased, first to 450 mbar, then to 250 mbar and finally to 20 mbar. After a reaction time of 8 hours the reaction mixture was vacuum filtered in order to remove the solid catalyst. The filtered product was then vacuum distilled for 1 hour at 120 °C and 2 mbar. To the none-volatile fraction approximately 125 g anionic ion exchange resin (Amberlyst A26) were added together with 100 g methanol and 20 g water. After heating to 60 °C for 2 h the mixture was filtered and evaporated at 90 °C under reduced pressure (2 mbar) yielding a clear liquid product.

### 9. Bisacetal Containing Chain Extender Diol

103 g of trimethylolpropane (TMP) were added into a 250 ml three neck round bottom flask equipped with an argon inlet, dean stark trap, and a thermocouple. 1.81 g of K10 catalyst and 38.6 g of 50 wt % glutaraldehyde solution in water were added. 20 g of hexane were added as the water carrying agent for the dean stark trap. The reaction mixture was heated to 77 °C, with the magnetic stirrer set at 450 rpm to suspend the catalytic particles in the reaction mixture. After 21 hours the reaction mixture was vacuum filtered in order to remove the solid catalyst The product was washed with water in order to remove free TMP. The washed product was then dried with a rotary evaporator for 6 hours at 65 °C under reduced pressure (18 mbar), yielding propane-1,3-diylbis(5-ethyl-1,3-dioxane-2,5-diyl)dimethanol as a clear colorless liquid with an OH value of 318 mg KOH/g and an acid value below 0.1 mg KOH/g.

### 10. Synthesis of Polyacetal Polyol Containing PU Materials

The polyacetal polyol 2 from example 2 was used for the synthesis of PU elastomer. Both, polyol and 1,4-butanediol, were dried at a 80 °C in a vacuum oven for 4 hours. 27.88 g of polyacetal polyol 2, 2.23 g of 1,4-butanediol and 0.0275 g 1,4-diazabicyclo[2.2.2]octane were mixed in a 100 ml beaker by a mechanical stirrer with a speed of 250 rpm, under argon at 80 °C. 9.89 g of 4,4′-MDI were added to the polyol component After one minute of mixing, a temperature of 110 °C was reached and the mixture was poured on a preheated Teflon mold at 120 °C. After 20 min, the material was transferred in a nitrogen oven and further cured at 80 °C for 16 h.

### 11. PU Depolymerization

18.8 g of the PU material synthesized in example 10 was cut into small pieces (2×4×40 mm) and added into a 100 ml round bottom flask equipped with a water cooled condenser. 25 g of aqueous 0.1 M HCl solution were added and the mixture was heated to 80 °C for 8 h with the magnetic stirrer using a speed of 300 rpm. After that, the obtained solid PU hard phase was filtered and separated from the solution with a quantitative yield and depolymerized further as described below. The remaining aqueous phase was transferred to a 250 ml flask containing 4 g anionic ion-exchange resin (Amberlyst A26). The mixture was stirred at room temperature for 15 min and the resin was removed by filtration. After evaporation of water at 70 °C under reduced pressure (20 mbar) for two hours 8.6 g (91% yield) of 1,4-butanediol were obtained with a purity of 98% according to ¹H NMR.

PU hard phase depolymerization: 6.3 g of the isolated PU hard phase were added to a 20 ml round bottom flask equipped with a water cooled condenser. 2 g of water and 2.6 g of 1,5,7-triazabicyclo[4.4.0]dec-5-ene (TBD) were added and the mixture was heated in oil bath at 150 °C for 48 h with the magnetic stirrer using a speed of 100 rpm. The temperature of the mixture slowly increased from 100 to 130 °C and the solid was liquefied. After cooling to room temperature, the mixture was washed with hot water, and the aqueous phase was filtered and dried, yielding a mixture of 1,4-butanediol and TBD. The insoluble fraction was vacuum distilled at 300 °C under reduced pressure of 2 mbar, followed by drying of the distillate to yield 3.05 g (83%) of 4,4′-Diaminodiphenylmethane (MDA) with a purity of 98% according to ¹H NMR. Furthermore, the mixture of 1,4-butanediol and TBD was diluted with water and transferred to a 250 ml flask containing 55 g cationic ion-exchange resin (Amberlyst 36). The mixture was stirred at room temperature for 15 min and the resin was removed by filtration. Water was evaporated at 70 °C under reduced pressure (20 mbar) for two hours and 1.54 g (92% yield) of 1,4-butanediol were obtained with a purity of 97% according to ¹H NMR.

### 12. Comparative Example 1. Polyacetal Polyol C1

Triethylene glycol divinylether (TEG DVE) was dried for at least 48 hours using molecular sieves prior to use. 114 g of dipropylene glycol, 172 g dried TEG DVE and 13.6 of trimethylolpropane were added into a 500 ml three neck round bottom flask equipped with an argon inlet, a mechanical stirrer and an thermocouple 0.63 g oxalic acid were added to the mixture, and the reaction mixture was heated to 80 °C. The mechanical stirrer was set to 450 rpm. After 5 hours 0.9 g 1,4-diazabicyclo[2.2.2]octane were added to the reaction mixture in order to neutralize the acid catalyst. The resulting product is an opaque white polyacetal polyol with an OH value of 58 mg KOH/g and an acid value of 2.2 mg KOH/g.

### 13. Comparative Example 2. Polyacetal Polyol C2

Polypropylene glycol with a molecular weight of 450 g/mol and triethylene glycol divinyl ether (TEG DVE) were dried for at least 48 hours using molecular sieves prior to use. 345.8 g of polypropylene glycol were added into a 500 ml three neck round bottom flask equipped with an argon inlet, a mechanical stirrer and a thermocouple 0.094 g para-toluenesulfonic acid were added to the flask, and the reaction mixture was heated to 40 °C. The mechanical stirrer was set to 450 rpm. After 4.5 hours 0.5 g N,N-dimethyl cyclohexylamine were added to the reaction mixture in order to neutralize the acid catalyst. The resulting product is an orange colored polyacetal polyol with catalyst salt still present and with an OH value of 61 mg KOH/g.

### 14. Comparative Example 3. Synthesis of PTHF2000 Containing PU Materials

PTHF 2000 and 1,4-butanediol were dried at a 80 °C vacuum oven for 4 hours. To a 100 ml beaker 28.09 g of PTHF2000, 2.20 g of butanediol and 0.03 g 1,4-diazabicyclo[2.2.2]octane were added and mixed by a mechanical stirrer using a speed of 250 rpm under argon at 80 °C. 9.71 g of 4,4′-MDI were added to the polyol component. After one minute of mixing, an temperature of 110 °C was reached and the mixture was poured on a preheated Teflon mold at 120 °C. After 20 min, the material was transferred in a nitrogen oven and further cured at 80 °C for 16 h.

### 15. Comparative Example 4. Hydrolysis of PTHF2000 Containing PU Materials

15 g of the PU material synthesized in comparative example 2 were cut into small pieces (2×4×40 mm) and added into a 100 ml round bottom flask equipped with a water cooled condenser. 20 g of aqueous 0.1 M HCl solution was added and the mixture was heated to 80 °C for 8 h with the magnetic stirrer using a speed of 300 rpm. The material remained intact and showed no signs of degradation.

### III. Methods Used

### 1. Ammonia-TPD: Experimental Procedure

About 200-500 mg of sample are given into the AutoChem TPD device and pretreated by heating the material with 20 K/min in nitrogen to 600 °C. After 10 min holding time at 600 °C the sample is cooled down to 100 °C and ammonia is adsorbed at this temperature. Excess of ammonia is then evaporated at 100 °C. The temperature programmed desorption of ammonia is performed from 100 to 600 °C with a heating rate of 10 K/min and 30 min holding time at 600 °C. The desorbed gases are measured continuously with TCD detector and mass spectroscopy. The concentration or amount of acid sites in the range of 100-600 °C is obtained in mmol/g after calibration. Deconvolution of the signal allows to determine the strength of the acid sites which correspond to the temperature, where the (one or more) maximum in the curve (Tₘₐₓ) is observed. A sample has sites of medium acid strength if a maximum or shoulder in the TPD curve is found in the range of 340-380 °C, lower acid strength corresponds to lower Tₘₐₓ, higher acid strength corresponds to higher Tₘₐₓ.
2. The specific surface area was analyzed according to DIN ISO 9277.
3. The following methods were used to determine the properties of the polyols: hydroxyl number was determined according to phthalic acid method EN ISO 4629-1:2016 and is given in mg KOH/g. Acid number was determined according to DIN EN ISO 2114 and is given in mg KOH/g.

### LITERATURE CITED

Polym. Degard. Stab. 2002, 75, 413-421
Polym. Degard. Stab. 2004, 147-151
ChemSusChem 2020, 13, 3835, 3843
T. Hashimoto et al., J. Appl. Polym. Sci., 2016, 133, 44088
Z. Petrovic et al., J Polym Environ., 2009, 17, 123-130
WO 2021/236385 A1
Ullmanns Encyklopädie der technischen Chemie [Ullmann's Encyclopedia of Industrial Chemistry], 4th edition, volume 19, pp. 62 to 65; p. 306.
U.S. Pat. No. 5,648,508
EP-A-0 709 253
M. O'Keeffe et al., J. Sol. State Chem., 152 (2000) p. 3-20
H. Li et al., Nature 402 (1999) p. 276 seq.
M. Eddaoudi et al., Topics in Catalysis 9 (1999) p. 105-111
B. Chen et al., Science 291 (2001) p. 1021-23
WO 02/088148
“Kunststoffhandbuch”, Volume 7, “Polyurethane”, Carl Hanser Verlag, 3rd edition 1993, chapters 3.1, 3.2 and 3.3.2, 3.4.4, 3.4.5 and 3.4.6 to 3.4.11
Houben-Weyl, Methoden der Organischen Chemie, Vol. XIV/2, Thieme-Verlag, Stuttgart 1963, p. 60f.
WO 2010/130652 A2

1: A process for preparing polyacetal polyol comprising:
reacting a compound (D1) having at least one OH group with a compound (C1) in the presence of a solid acid catalyst;
wherein:
the compound (C1) is selected from the group consisting of a vinyl ether, an aldehydes, and an acetal; and
the solid acid catalyst is selected from the group consisting of:
a catalyst obtained by a process comprising calcining a precursor of an oxide of at least one element selected from the group consisting of Ge, Sn, B, Al, Ga, Zn, Cu, Fe, Mn, Ni, Cr, Mo, P, S, W, Nb, Ti, Zr, Hf, Y, La, Ce, Yb, and Si, at a temperature of 150 °C to 1150 °C to obtain the oxide;
a silica-alumina hydrate;
a clay compound containing Si and Al;
a zeolite having a structure selected from the group consisting of BEA, EMT, ERI, EUO, FAU, HEU, LTA, LTL, MAZ, MOR, MTW, NES, OFF, and TON;
a cation exchange resin; and
a MOF catalysts.

2: The process according to claim 1, wherein the compound (D1) has a molecular weight of less than 5000 g/mol.

3: The process according to claim 1, wherein the compound (D1) has a functionality of 1 to 8.

4: The process according to claim 1, wherein reacting comprises performing polyaddition, polycondensation, or transacetalization

5. (canceled)

6: The process according to claim 1, wherein the compound (D1) is selected from the group consisting of a monool, a diol, and a triol with 1 to 20 C-atoms.

7: The process according to claim 1, wherein the compound (C1) is selected from the group consisting of a divinyl ether and a mono vinyl ether.

8: The process according to claim 1, wherein the compound (C1) is selected from the group consisting of a linear aliphatic aldehyde, a branched aliphatic aldehyde, an aromatic aldehydes, and a ketone.

9: The process according to claim 1, wherein the compound (C1) is selected from the group consisting of an aliphatic acetal, an aromatic acetal, and a ketal.

10: The process according to claim 1, wherein the process comprises at least one separation selected from the group consisting of filtration, distillation, and washing.

11: A polyacetal polyol obtained by the process according to claim 1.

12: The polyacetal polyol according to claim 11, wherein the polyacetal polyol has at least one acetal group and 1 to 8 OH end groups.

13: The polyacetal polyol according to claim 11, wherein the polyacetal polyol has an OH value of 10 to 1200 mgKOH/g.

14: A process for preparing a polyurethane, comprising reacting the polyacetal polyol according to claim 11.

15: A process for preparing a polyurethane,
comprising reacting the polyacetal polyol according to claim 11 with at least one isocyanate.

16: A polyurethane obtained by the process according to claim 15.

17: A process for recycling the polyurethane according to claim 16,
comprising treating the polyurethane with a solution at a pH of 0 to 6.

18: The process according to claim 17, wherein the process comprises at least one selected from the group consisting of:
separating an obtained liquid phase and solid hard phase, optionally also separating a resulting gas phase;
neutralizing an acidic liquid phase using a base or ion exchange resin; and
separating water and components obtained using distillation, precipitation, or extraction.
